(19) United States
(12) Patent Application Publication
(10) Pub. No.: US 2003/0129458 A1
(43) Pub. Date: Jul. 10, 2003

(54) AN ENERGY SYSTEM FOR DELIVERING INTERMITTENT PULSES

(76) Inventor: JOHN C. BAILEY, COLUMBIA STATION, OH (US)

Correspondence Address: ROBERT W WELSH, EVEREADY BATTERY COMPANY INC, 25225 DETROIT ROAD, P O BOX 450777, WESTLAKE, OH, 44145

(21) Appl. No.: 09/388,953

(22) Filed: Sep. 2, 1999

(51) Int. Cl. H01M 2/02; H01M 4/02; H01M 16/00

(52) U.S. Cl. 429/9; 429/7; 429/176; 429/209

(57) ABSTRACT

An energy system for delivering current to a load is provided. The energy system comprises a first energy source and a second energy source electrically connected in parallel. The first energy source comprises an electrochemical capacitor, and the second energy source comprises an electrochemical cell. The cell comprises a container, a first electrode and a second electrode, wherein the ratio of the electrode interfacial area of said cell, in square centimeters, to the container volume of said cell in cubic centimeters, is not more than about 27 cm⁻¹.

### BACKGROUND OF THE INVENTION

Devices such as power tools, digital communication devices and portable computers require an energy system capable of providing high rates of discharge in current pulses in an operating cycle which otherwise requires a much lower operating current. These devices also require acceptable operating times. Attempts to address these needs have focused on energy systems that purport to combine the high rate attributes of rechargeable batteries typically used in portable devices with the high power attributes of a capacitor. However, many rechargeable batteries suffer from a lack of capacity associated with their construction that has an adverse effect on operating time. Rechargeable cells are known that are manufactured with a “jellyroll” electrode assembly. Such an electrode assembly comprises a positive electrode strip, a negative electrode strip, and separator material covering both sides of one strip so as to electrically isolate the opposing electrodes once the strips are wound into a jellyroll. The electrode assembly can be further processed if desired, for example by compressing the jellyroll to achieve a particular shape. The assembly is then inserted into a container. The container also may have a variety of form factors, including cylindrical and prismatic shapes.

The jellyroll electrode assembly configuration common with many cylindrical rechargeable cells is recognized in the art as reducing the internal resistance of the cell, enabling an increased rate of discharge. The reduction in internal resistance of such cells is attributable in part to the relatively large amount of electrode interfacial area per cell volume that results from wound constructions. However, this ability to discharge at a high rate is achieved at the expense of cell capacity, due at least in part to the amount of inactive material, such as the separator material, which must be utilized within the cell, and the void spaces resulting from the use of winding mandrels and the like. Further, complexities associated with the manufacture of such jellyroll cells render them costly to produce.

There is therefore a need for an energy storage system that can deliver sufficient high rates of discharge and acceptable capacity with a minimum of expense.

### BRIEF DESCRIPTION OF THE DRAWINGS

FIG. 1 is a circuit diagram of an energy storage system in accordance with the present invention.

FIG. 2 is a chart illustrating the power requirements of a load during a pulsed duty cycle as a function of time for a jellyroll construction battery.

FIG. 3 is a chart illustrating the power requirements of a load during a pulsed duty cycle as a function of time for a jellyroll construction battery electrically coupled with a capacitor.

FIG. 4 is a chart illustrating the power requirements of a load during a pulsed duty cycle as a function of time for a bobbin construction battery.

FIG. 5 is a chart illustrating the power requirements of a load during a pulsed duty cycle as a function of time for a bobbin construction battery electrically coupled with a capacitor.

### DETAILED DESCRIPTION OF THE INVENTION

The present invention in one form is a unique energy system for delivering current to a load comprising a first energy source and a second energy source. The first energy source comprises an electrochemical capacitor and the second energy source comprises a battery, wherein the battery comprises a low electrode interfacial area electrochemical cell. The first and second energy sources are electrically connected in parallel to enable them to deliver the required current to a load. The electrochemical cell has at least one positive electrode and at least one negative electrode and a cell container. The positive and negative cell electrodes are disposed relative to each other such that the ratio of the interfacial area of said electrodes to the cell container volume is not more than about 27 cm⁻¹. As used herein a “low electrode interfacial area electrochemical cell” is an electrochemical cell where the ratio of the electrode interfacial area to the cell container volume is not more than about 27 cm⁻¹.

The present invention recognizes that an advantageous combination of battery and capacitor for delivering current to a load having pulsed power requirements is one in which the battery comprises an electrochemical cell designed for maximizing cell capacity as opposed to discharge rate, leaving the high rate pulsed power demands from the device to be addressed primarily by the capacitor. Therefore, the energy system in the present invention utilizes a cell wherein the ratio of electrode interfacial area, in square centimeters, to electrochemical cell container volume in cubic centimeters, is not more than about 27 cm⁻¹. Restricting the electrode interfacial area of the electrochemical cell in this manner allows a more efficient utilization of the volume of the cell container, which can be devoted to electrochemically active materials or to accommodate one or more capacitors or other desired structural elements or features.

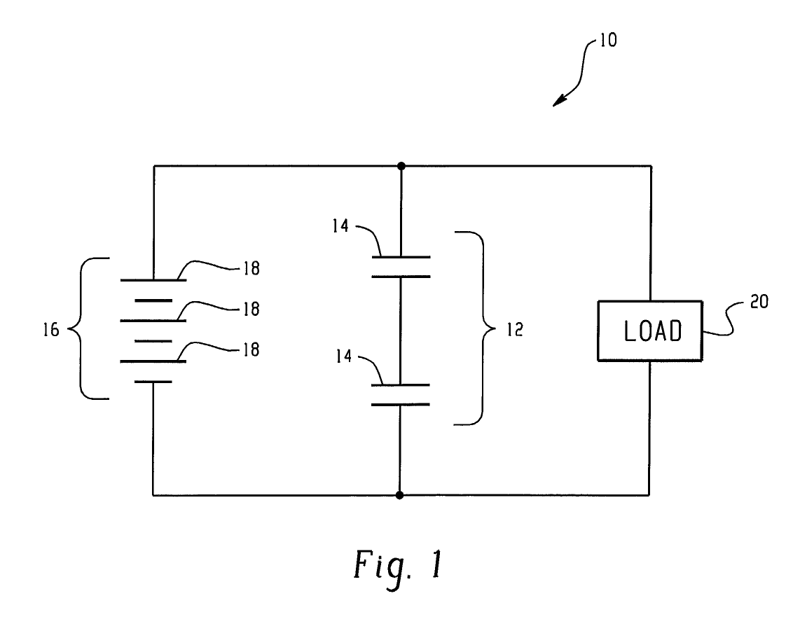

Referring to FIG. 1, there is illustrated a circuit diagram of an energy system of the present invention. The system 10 includes a first energy source 12 capable of providing high current during the current pulse of a duty cycle. Preferably, the first energy source comprises one or more electrochemical capacitors 14. Such an electrochemical capacitor preferably has at least one capacitor electrode fabricated from a metal oxide and at least a second capacitor electrode and an electrolyte. The second capacitor electrode can be made from the same or a similar metal oxide or may be fabricated from an entirely different material altogether, including a polymer, such as polyanile, polypurrole, polyurethane, polyacrylomide and combinations thereof. One or more of the capacitor electrodes may be fabricated of carbon based material. The capacitor electrolyte may be organic or alkaline or proton conducting. Capacitors such as those described in U.S. Pat. No. 5,777,428 entitled “Aluminum Carbon Composite Electrode” and U.S. Pat. No. 5,621,601 entitled “High Performance Double Layer Capacitors Including Aluminum Carbon Composite Electrodes,” the disclosures of which are incorporated herein, are suitable for use in the invention described herein. However, it will be appreciated by one skilled in the art that the present invention can be practiced with any electrochemical capacitor suitable for supplying high current during a current pulse demand. As used herein, “electrochemical capacitor” refers to capacitors exhibiting double layer capacitance in which the interfacial capacitance at the electrode/electrolyte interface can be modeled as two parallel sheets of charge, and to capacitors exhibiting pseudo capacitance in which charge transfer between the electrode and the electrolyte occurs as a result of surface faradaic reactions at the interface of the electrode and the electrolyte.

In a preferred embodiment, the first and second energy sources are comprised of off the shelf electrochemical capacitors and cells and are therefore housed in distinct containers. Many different form factors are available for such containers, as is known in the art, including substantially flat cans, round cylinders and flexible foil pouches. The selection of an appropriate form factor for such containers will be dictated in large part by the volume available to accommodate the energy system of the within invention and the power demands of the associated device. In an alternate embodiment, the first energy source is positioned within the container for the electrochemical cell of the second energy source. In this alternate embodiment, the first energy source preferably does not have a discrete container, to enable more volume in the electrochemical cell container to be occupied with active material or other desired features.

The energy storage system 10 includes a second energy source 16 connected in parallel with the first energy source 12. The second energy source 16 is capable of delivering current for an extended period of time but may not be able to provide a high current at a high voltage, as is required of certain pulsed power applications such as cellular telephones. As such, the second energy source may be one or more electrochemical cells 18 having a ratio of electrode interfacial area to cell container volume of not more than 27 cm⁻¹, including but not limited to conventional alkaline primary cells in standard sizes. The electrochemical cells of the second energy source are not limited to any particular chemistry. Such cells can utilize chemistries such as lead acid, nickel cadmium, nickel metal hydride, lithium ion (including liquid and polymer electrolyte cells), lithium metal, zinc air, and combinations thereof. Such cells are preferably constructed to maximize the capacity of the cell rather than the discharge rate capabilities of the cell by minimizing the amount of electrode interfacial area per cell volume.

In the preferred embodiment, the electrochemical cell of the second energy source is a conventional primary alkaline cell having a “bobbin construction.” A “bobbin cell” as used herein is a cell having one or more “bobbin electrodes”. As used herein, a “bobbin electrode” refers to an electrode with an opening, usually annular in shape and located in the center of the electrode, that typically passes through the electrode from one end to an opposing end to accommodate one or more additional elements, such as a second electrode, electrolyte, or a current collector. A “bobbin electrode” as used herein also includes an electrode with an off center opening and further includes an electrode with an opening that does not pass through the entire electrode from one end to an opposing end. In a preferred embodiment, the battery of the second energy source is at least one bobbin cell such as is available from Eveready Battery Company, Inc.

The first and second energy sources are electrically coupled together to enable both the first and second energy sources to deliver current to a load 20. Optionally, circuitry can be added to the circuit shown in FIG. 1 to condition the output of the first and second energy sources or to provide certain safety features, such as preventing short circuiting when the energy system is connected to a load, such as a cellular telephone. Additionally, a switch or other like component can be added to the circuit shown in FIG. 1 between the first and second energy sources to disconnect the first and second energy sources from each other. Such a disconnect function may be desirable under certain circumstances, for example, where the capacitor self discharges. In this circumstance, the battery would be continuously recharging the capacitor even when the energy system was electrically disconnected from a device such as a cellular telephone.

The “electrode interfacial area” of the cell of the second energy source refers to the common area faced on opposing sides by the active material of cell electrodes having opposing polarities. In a conventional bobbin construction cell, one electrode (usually the cathode) has an annular opening containing the second electrode (usually the anode) and the separator material. The height of the inner electrode is usually less than the height of the outer electrode to prevent internal shorting that may occur from unintended contact between the two electrodes. For such a cell, the electrode interfacial area as used herein refers to the surface area of a cylinder (not including the area of the cylinder ends) having a diameter equal to the inner diameter of the cathode less the thickness of the separator, and a height equal to the height of the inner electrode. For cells constructed from multiple electrode strips with active material on all or a portion of the strip and wound into jellyrolls or folded together in an accordion arrangement, the electrode interfacial area as used herein refers to that area faced by the active material of opposing electrodes. By way of example, if each side of one electrode strip has an active material area of 1.345 by 6.4 inches, and each side of the opposing electrode strip has an active material area of 1.415 by 6.0 inches, the electrode interfacial area would be 2×1.345×6.0 inches.

The “cell container volume” as used herein is determined by measuring the outside dimensions of the cell container. For example, for standard size cylindrical cells, button cells and the like, the cell volume refers to the volume of a cylinder having the largest container height and diameter. For prismatic containers, the container volume is determined by using the largest container length and width and assuming the container is a rectangle.

### EXAMPLE 1

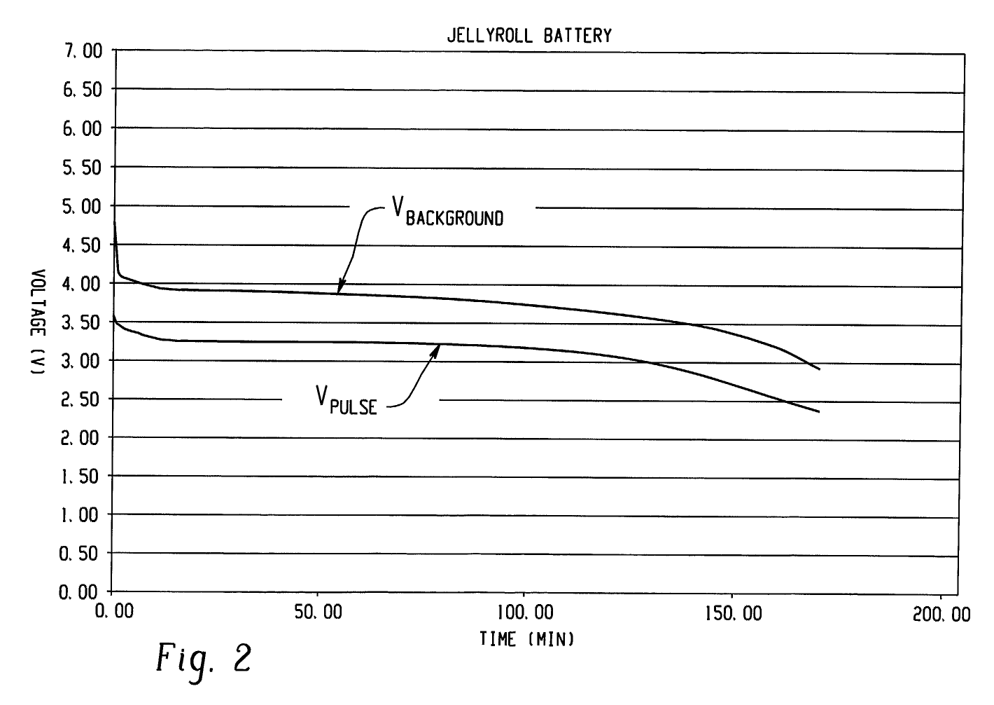

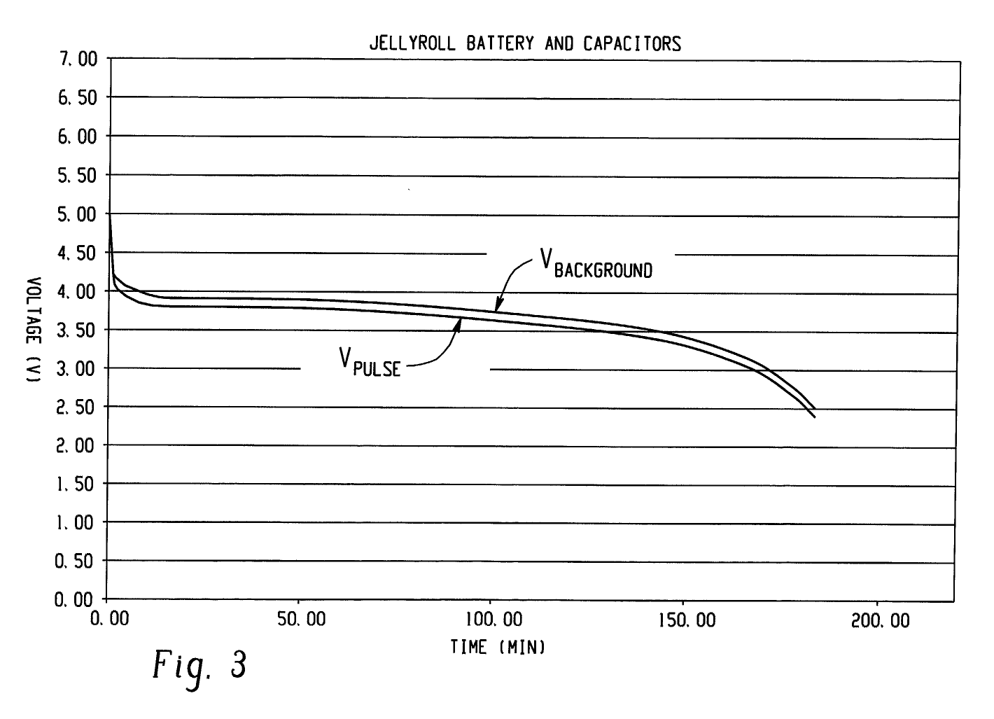

Energy systems utilizing jellyroll cells are summarized in FIGS. 2 and 3. The energy systems represented in FIGS. 2 and 3 each included a battery comprising electrochemical cells. The energy system of FIG. 2 did not include any electrochemical capacitors, while the system of FIG. 3 did include electrochemical capacitors. The battery portion of the energy system represented in FIGS. 2 and 3 comprised three lithium FeS₂ 1.5 volt wound cylindrical cells. The three cells were connected in series. Each cell had an electrode interfacial area of about 104 cm² for each cell. The cell container volume for each cell was about 3.85 cm³ based upon the height and diameter of the cell container. The ratio of interfacial electrode area to cell container volume was therefore about 27 cm⁻¹ for each cell.

The energy system of FIG. 3 additionally comprised two 8 Farad 2.3 volt capacitors connected in series as are available from Maxwell Technologies, San Diego, Calif., under product number PC 223. The series-connected capacitors were connected in parallel with the series connected cells.

In each case, the energy system was electrically connected to a load and a pulsed discharge duty cycle was applied to simulate a GSM telecommunications system discharge protocol. The duty cycle consisted of a 1.34 A discharge for 0.55 milliseconds (the pulse discharge) followed by a 164 mA discharge for 4 milliseconds (the background discharge).

The energy system of FIG. 2 discharged for a period of about 170 minutes to a cutoff voltage of 2.4 volts. The energy system of FIG. 3 discharged for a period of about 184 minutes to a cutoff voltage of 2.4 volts. The capacitors extended the discharge time of the energy system using jellyroll electrochemical cells by approximately 8 percent.

### EXAMPLE 2

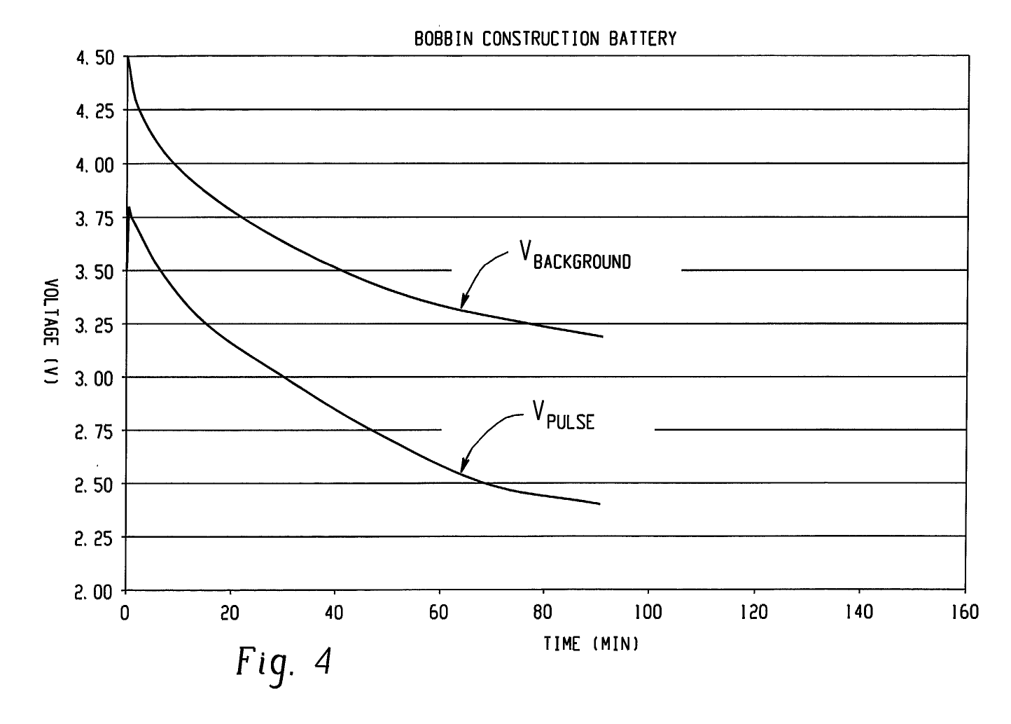

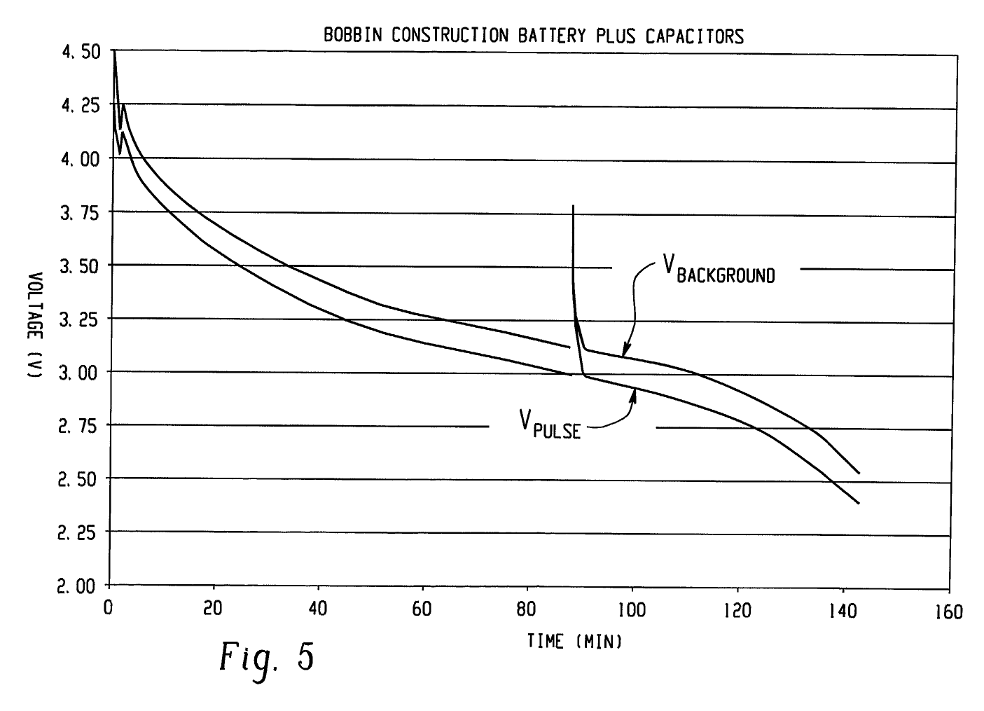

In contrast, a comparison of energy systems utilizing cells having a lower electrode interfacial area is presented in FIGS. 4 and 5. The energy systems represented in FIGS. 4 and 5 also each included a battery comprising electrochemical cells. The energy system of FIG. 4 did not include any electrochemical capacitors, while the system of FIG. 5 did include electrochemical capacitors. The battery portion of the energy system represented in FIGS. 4 and 5 comprised three standard cylindrical primary alkaline AAA 1.5 volt cells as are available from the Eveready Battery Company, Inc. under product number E92. The three cells are connected in series. The cells have a bobbin construction and an electrode interfacial area of 6.65 cm², based upon the inner diameter of the cathode less the separator thickness and the height of the anode. The cell container volume is about 3.85 cm³ based upon the largest height and diameter of the cell container. The ratio of electrode interfacial area to cell container volume is therefore about 1.72 cm⁻¹. The energy system in FIG. 5 additionally comprises two 8 Farad 2.3 volt capacitors connected in series as are available from Maxwell Technologies, San Diego, Calif., under product number PC 223. The series-connected capacitors are, as in the previous example, connected in parallel with the series connected cells.

In each case represented in FIGS. 4 and 5, the energy system was connected to a load. The same duty cycle was applied to the systems as was applied in Examples 1 and 2, that is, a 1.34 amp discharge for 0.55 milliseconds (the pulse discharge) followed by a 164 milliamp discharge for 4 milliseconds (the background discharge).

The energy system of FIG. 4 discharged for a period of about 91 minutes to a cutoff voltage of 2.4 volts. The energy system of FIG. 3 discharged for a period of about 142 minutes to a cutoff voltage of 2.4 volts. The capacitors extended the discharge time of the energy system using electrochemical cells having a low electrode interfacial area by approximately 56 percent.

Many electrochemical capacitors available on the market will have a cycle life of many hundreds of cycles, giving them a potential life far in excess of the electrochemical cells of the second energy source of the within invention. In a preferred embodiment of the present invention, the cells of the second energy source are disposed within a housing. The electrochemical capacitors of the first energy source can have a prismatic or other container as is available on the market, and are also disposed within the same housing. In this embodiment, the housing can be compartmented such that the primary cells are located in one such compartment with easy access, while the capacitors are located in a separate compartment sealed or otherwise closed so as to prevent access. In this embodiment the housing can be retained by the end user when the life span of the cells of the second energy source has been exhausted, and the end user simply replaces the spent cells with new cells.

In an alternate embodiment, the capacitors of the first energy source are located within the device, while the cells of the second energy source are located in a discrete housing. In this embodiment, the housing can, if desired, be discarded by the end user when the life span of the cells of the second energy source has been exhausted. The end user would then replace the housing containing spent cells with a new housing containing new cells.

In a yet another alternate embodiment, the capacitors of the first energy source are located inside the container for the electrochemical cells of the second energy source. In this embodiment, the first and second energy sources are located such that the addition of the first energy source to the second energy source does not require any additional volume beyond that required of the first energy source.

It will be appreciated that many different combinations of electrochemical cells, capacitors, containers and housings are possible without departing from the within invention. The proceeding discussion is provided for example only. Other variations of the claimed inventive concepts will be obvious to those skilled in the art. Adaptation or incorporation of known alternative devices and materials, present and future is also contemplated. The intended scope of the invention is defined by the following claims.

What is claimed is:

1. An energy system for delivering current to a load comprising:
a first energy source comprising at least one electrochemical capacitor, and
a second energy source electrically connected in parallel to said first energy source, said second energy source comprising at least one electrochemical cell, said cell comprising a cell container, a first electrode and a second electrode, wherein the ratio of the electrode interfacial area of said cell, in square centimeters, to the container volume of said cell in cubic centimeters, is not more than about 27 cm⁻¹.

2. The energy system of claim 1, wherein at least one electrochemical cell has a bobbin construction.

3. The energy system of claim 2, wherein said cell is a primary cell.

4. The energy system of claim 1, wherein at least one capacitor is disposed within at least one of said cell containers.

5. The energy system of claim 4, wherein said at least one capacitor further comprises a capacitor container.

6. The energy system of claim 1, wherein said first energy source further comprises a capacitor container and said second energy source further comprises a battery container.

7. The energy system of claim 6, wherein said first and second energy sources are disposed in a single housing.

8. The energy system of claim 7, wherein said housing is divided into a plurality of compartments.
